(19) United States
(12) Patent Application Publication
(10) Pub. No.: US 2010/0050977 A1
(43) Pub. Date: Mar. 4, 2010

(54) MAGNESIUM ALLOY ENGINE BLOCK

(75) Inventor: Hoon Mo Park, Seoul (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/323,517

(22) Filed: Nov. 26, 2008

(30) Foreign Application Priority Data
Sep. 4, 2008 (KR) 10-2008-0087430

(51) Int. Cl. F02F 1/00; F02B 75/00

(52) U.S. Cl. 123/195 R

(57) ABSTRACT

The invention features a magnesium alloy engine block. Preferably, the magnesium alloy engine block includes a crankcase formed of magnesium alloy and having a plurality of cylinder chambers, a cylindrical liner fitted into the cylinder chambers, and an integral insert embedded into the crankcase between and below the cylinder chambers and having a crankshaft support part, extension parts which upwardly extend from the crankshaft support part toward the cylinder chambers, and upper coupling parts, the crankshaft support part, the extension parts and the upper coupling parts being integrally formed with one another.

### CROSS-REFERENCE TO RELATED APPLICATIONS

This application claims under 35 U.S.C. §119(a) priority to Korean Application No. 10-2008-0087430, filed on Sep. 4, 2008, the disclosure of which is incorporated herein by reference in its entirety.

### BACKGROUND OF THE INVENTION

1. Field of the Invention

The present invention relates to a magnesium alloy engine block wherein cylinder chambers, in which pistons will be disposed, are formed, inserts are fitted into the cylinder chambers, and a water jacket and oil drains are formed.

2. Background Art

To design a lightweight engine, structural improvements to an engine block and the application of component technology to enhance the durability of the engine block and maximize a lightening effect (a lighter weight) are considered. Accordingly, when an alloy of magnesium is employed in order to decrease the weight of an engine, it becomes necessary to prevent the thermal deformation and increase the corrosion resistance of an engine block.

Accordingly, as the engine block is the main component of an automotive vehicle, lightening of the engine block is desirable, so that driving performance can be suitably improved through elevated fuel economy, environmental pollution can be minimized and front-to-rear weight ratio can be suitably optimized. Thus, magnesium alloy engine blocks have been developed by automobile manufacturers in order to maximize lightening of the engine blocks by changing the basic material of the engine blocks from the presently-used aluminum to magnesium.

An important consideration when applying magnesium alloy to an engine block is the poor heat resistance and corrosion resistance of magnesium as compared to aluminum. Efforts to overcome the poor heat resistance and corrosion resistance have been made in the field of design and material technology. Heat-resistant materials having high temperature strength and corrosion resistance have been described, however these materials can be costly.

Accordingly, there remains a need in the art for structural modification and application of element technology to overcome the limitations of those materials and to enhance the durability and provide a lighter weight engine block.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a magnesium alloy engine block which is of light weight, has improved heat resistance and strength, and has considerable corrosion resistance.

In one preferred embodiment, the present invention features a magnesium alloy engine block for a vehicle, preferably having an upper end to which a cylinder head is coupled, comprising a crankcase formed of magnesium alloy and having a plurality of cylinder chambers in which pistons are to be disposed and a water jacket which is suitably formed around the cylinder chambers and is coated on an inner surface thereof through plasma electrolytic oxidation; a cylindrical liner suitably fitted into the cylinder chambers; and an integral insert embedded into the crankcase between and below the cylinder chambers and preferably having a crankshaft support part which is suitably defined with a crankshaft insertion hole at a center portion thereof, extension parts which upwardly extend from the crankshaft support part toward the cylinder chambers, and upper coupling parts which are suitably formed at ends of the extension parts and are locked with upper bolts inserted into the crankcase through a cylinder head, the crankshaft support part, the extension parts and the upper coupling parts being suitably integrally formed with one another.

According to another embodiment of the present invention, a mounting frame is suitably installed on a lower end of the integral insert, and lower coupling parts are preferably formed on both sides of the crankshaft insertion hole of the crankshaft support part to be locked with lower bolts which pass through the mounting frame.

According to another preferred embodiment of the present invention, preferably, the integral insert is integrally formed of compacted graphite iron and is then cut in a manner such that the crankshaft insertion hole is bisected and the integral insert is suitably divided into an upper insert and a lower insert.

According to another preferred embodiment of the present invention, the crankshaft support part of the integral insert suitably has the shape of a plate which is defined with the crankshaft insertion hole at a center portion thereof and has a suitable predetermined thickness, the extension parts have the shapes of skeletons which connect the crankshaft support part and the upper coupling parts, and flange portions are preferably formed on outer surfaces of the extension parts.

According to another preferred embodiment of the present invention, the extension parts are suitably composed of a left skeleton, a central skeleton and a right skeleton which upwardly extend from a left end, an upper end and a right end, respectively, of the crankshaft support part, branch skeletons are branched from an upper end of the central skeleton to extend upward, and the upper coupling parts are respectively formed on upper ends of the skeletons.

According to another preferred embodiment of the present invention, ribs are projectedly formed on both ends of the respective extension parts so that adhesion is suitably improved when the integral insert is cast along with the crankcase.

According to another preferred embodiment of the present invention, an annular groove is suitably defined around each upper coupling part so that adhesion is improved when the integral insert is cast along with the crankcase.

According to another preferred embodiment of the present invention, an oil drain is suitably formed outside the cylinder chambers in the crankcase, and is preferably composed of a plurality of upper fluid paths which are formed side by side parallel to the cylinder chambers, an intermediate fluid path which suitably connects lower ends of the upper fluid paths and is formed to extend in a horizontal direction, and a plurality of lower fluid paths which downwardly extend from the intermediate fluid path.

According to still further embodiments of the present invention, the liner preferably comprises an integral liner which is formed of aluminum alloy such that a plurality of cylindrical liners are suitably integrated with one another, and the cylinder chambers of the crankcase communicate with one another to constitute an integral cylinder chamber such that the integral liner can be fitted into the integral cylinder chamber.

According to a still other further embodiments of the present invention, the water jacket is preferably coated by an electrode inserted therein with electrolytic which is circulated through a cooling water inlet and outlet of the water jacket, and the electrode has a suitable configuration corresponding to the water jacket and is inserted in such a way as not to be brought into contact with an inner surface of the water jacket.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and other advantages of the present invention will be more clearly understood from the following detailed description taken in conjunction with the accompanying drawings, which are given hereinafter by way of illustration only, and thus are not limitative of the present invention, and wherein:

FIG. 1 is an exploded perspective view illustrating a magnesium alloy engine block in accordance with an embodiment of the present invention;

FIG. 2 is a perspective view illustrating integral inserts of the magnesium alloy engine block shown in FIG. 1;

FIG. 3 is a sectional view of the integral insert shown in FIG. 2;

FIG. 4 is a perspective view illustrating oil drains of the magnesium alloy engine block shown in FIG. 1;

FIG. 5 is a sectional view illustrating the installed state of the oil drain shown in FIG. 4;

FIG. 6 is a perspective view illustrating a water jacket of the magnesium alloy engine block shown in FIG. 1;

FIG. 7 is a perspective view illustrating electrodes for coating the water jacket shown in FIG. 6; and

FIG. 8 is a perspective view illustrating an apparatus for coating the water jacket shown in FIG. 6.

### DESCRIPTION

As described herein, the present invention includes a magnesium alloy engine block for a vehicle, having an upper end to which a cylinder head is coupled, comprising a crankcase formed of magnesium alloy and having a plurality of cylinder chambers in which pistons are to be disposed, a cylindrical liner fitted into the cylinder chambers, and an integral insert embedded into the crankcase between and below the cylinder chambers and having a crankshaft support part, extension parts, and upper coupling parts, the crankshaft support part, the extension parts and the upper coupling parts being integrally formed with one another.

In one embodiment, the crankcase further comprises a water jacket which is formed around the cylinder chambers.

In another embodiment, the water jacket is coated on an inner surface.

In another further embodiment, the water jacket is coated on an inner surface thereof through plasma electrolytic oxidation.

In a related embodiment, the integral insert embedded into the crankcase between and below the cylinder chambers further comprises a crankshaft support part which is defined with a crankshaft insertion hole at a center portion thereof.

In another embodiment, the extension parts upwardly extend from the crankshaft support part toward the cylinder chambers.

In a further embodiment, the upper coupling parts are formed at ends of the extension parts and are locked with upper bolts inserted into the crankcase through a cylinder head.

The invention can also include a motor vehicle comprising a magnesium alloy engine block as described in any of the aspects herein.

Reference will now be made in greater detail to preferred embodiments of the invention, examples of which are illustrated in the accompanying drawings. Wherever possible, the same reference numerals will be used throughout the drawings and the description to refer to the same or like parts.

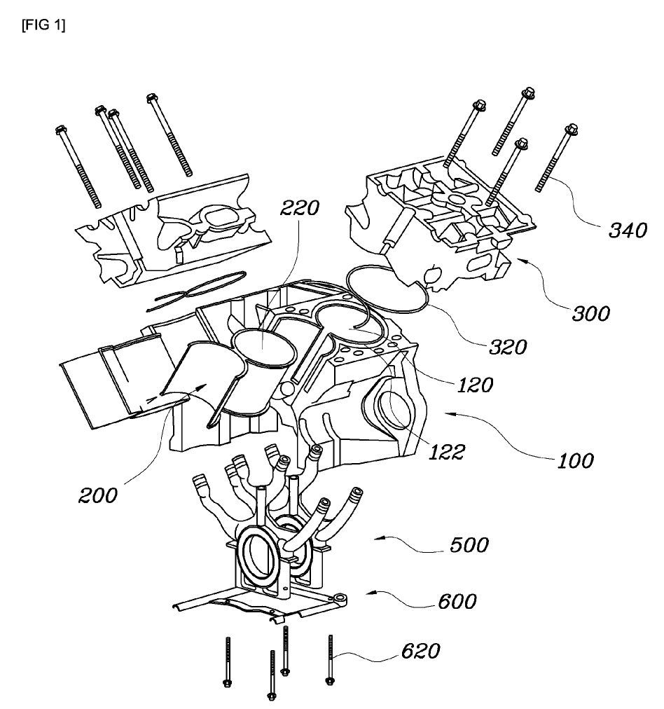

FIG. 1 is an exploded perspective view illustrating an exemplary magnesium alloy engine block in accordance with a preferred embodiment of the present invention. The magnesium alloy engine block in accordance with certain preferred embodiments of the present invention include a crankcase 100 formed of magnesium alloy and having a plurality of cylinder chambers 120 in which pistons are to be suitably disposed and a water jacket 122 which is preferably formed around the cylinder chambers 120 and is suitably coated on the inner surface thereof preferably through plasma electrolytic oxidation; a cylindrical liner 220 preferably fitted into the cylinder chambers 120; and an integral insert 500 preferably embedded into the crankcase 100 between and below the cylinder chambers 120 and having a crankshaft support part 520 which is suitably defined with a crankshaft insertion hole 522 at the center portion thereof, extension parts 540 which upwardly extend from the crankshaft support part 520 toward the cylinder chambers 120, and upper coupling parts 560 which are suitably formed at the ends of the extension parts 540 and are locked with upper bolts 340 inserted into the crankcase 100 through a cylinder head 300, the crankshaft support part 520, the extension parts 540 and the upper coupling parts 560 being preferably integrally formed with one another.

In preferred embodiments, as the material of the magnesium engine block, magnesium alloy is preferably used for the purpose of lightening the engine block. In particular preferred embodiments magnesium alloy is preferably used, and lightening of the engine block can be suitably accomplished, and the strength, heat resistance and corrosion resistance demanded of the magnesium alloy engine block can be suitably ensured.

In further preferred embodiments, for example as shown in FIG. 1, the magnesium engine block according to the present invention is generally composed of the crankcase 100 formed with the cylinder chambers 120, the liner 220 fitted into the cylinder chambers 120, the cylinder head 300, the integral insert 500, and a mounting frame 600. In further embodiments, the crankcase 100 is suitably formed with the cylinder chambers 120 in which the pistons (not shown) are to be disposed. In one exemplary embodiment, the illustrated embodiment is a six cylinder V-3 type parallel engine. Preferably, three cylinder chambers 120 are suitably formed on each side, and the liner 220 is fitted into the respective cylinder chambers 120. In other further embodiments, a gasket 320 is suitably interposed between the cylinder head 300 and the crankcase 100.

In preferred embodiments, the respective cylinder chambers 120 are organically connected with one another in order to accomplish the light weight of the engine block and prevent thermal deformation. Accordingly, in other further embodiments, the cylinder chambers 120 on each side are suitably formed to be arranged in line and communicate one with another such that they have the shape of an integral cylinder chamber. Accordingly, in further preferred embodiments, an integral liner 200 is suitably formed in a manner such that a series of cylindrical liners are preferably integrated one with another.

In certain embodiments of the invention, the integral liner 200, in which multiple cylindrical liners are suitably integrated one with another, is integrally manufactured such that, for example, four cylindrical liners in the case of an in-line four cylinder engine or, for example, three cylindrical liners on each of left and right sides in the case of a V6 type parallel engine are suitably connected one with another as a single structure through low pressure die casting by using A390 alloy (Al-17% Si-4% Cu) being a monoblock material. In further embodiments, the integral liner 200 is suitably applied when casting the magnesium alloy engine block. Preferably, the integral aluminum alloy liner 200 manufactured in this way can also be suitably applied to a high pressure casting process without creating a substantial difference, in substantially the same way as in a conventional cylindrical liner forming process. In the case of a conventionally used individual cylindrical liner, since an interbore area is divided into the liner and an aluminum alloy block, a distance of 8.0-11 mm is ensured, whereas, as described herein, in the case of the integral liner 200, since an interbore area forms an integrated structure using hyper-eutectic Al—Si alloy, in preferred embodiments, a distance of 5.0-5.5 is suitably sufficient. Therefore, in further embodiments, the entire length of the engine block can be suitably decreased, preferably at least by 12 mm, 11 mm, 10 mm, 9 mm, 8 mm, 7 mm, and preferably at least by 9 mm in the case of an in-line four cylinder engine or a V8 type engine or at least by 4 mm, 5 mm, 6 mm, 7 mm, 8 mm or greater, preferably at least by 6 mm or greater in the case of a V6 type engine. Thus, according to the embodiments described herein there is a decrease in the length of the magnesium alloy engine block and also a decrease in the length of all component parts such as a crankshaft, a bedplate, a camshaft and a cylinder head which are attached to the engine block. According then to preferred embodiments of the invention as described herein, the lightening and compacting effects of the engine are considerable. In other embodiments, the low pressure die casting described in the present invention preferably utilizes the mass-production process and the materials which are currently adopted in the art, to ensure stable quality, and can be suitably adapted while not exerting substantial pressure on main mass-production casting processes and facilities used in the manufacture of the magnesium alloy engine block. Preferably, in the hyper-eutectic Al—Si integrated structure, because aluminum alloy providing advantages in terms of entire structural strength and having heat resistance superior to the magnesium alloy is preferably used as the material of the interbore area where the thermal load is greatest, the increase of the material cost in the development of the magnesium alloy engine block can be suitably reduced to some extent. In related embodiments, the A390 alloy has a suitably smaller difference in thermal expansion coefficient with respect to the magnesium alloy than the material of the cylindrical aluminum alloy liner which preferably manufactured by a rapid solidification process, and is in further embodiments advantageous in terms of bore deformation and residual stress.

According to other preferred embodiments of the invention, the integral insert 500 is preferably embedded into the crankcase 100 between and below the cylinder chambers 120. Preferably, the integral insert 500 is suitably formed of compacted graphite iron (CGI).

TABLE 1

| Material | T.S | Y.S | EL. | HB |
|---|---|---|---|---|
| Gray | 245 | 186 | — | 190~240 |
| CGI | 411~481 | 325~341 | 0.9~1.8 | 229~241 |

| | C | Si | Mn | P | S | Cr | Cu | Sn | Mg | Ti |
|---|---|---|---|---|---|---|---|---|---|---|
| Wt % | 3.5~3.8 | 1.8~2.5 | 0.2~0.5 | ~0.05 | ~0.03 | ~0.05 | 0.5~1.4 | 0.01~0.1 | ~0.03 | ~0.03 |

The exemplary compositions of CGI are given in Table 1.

In further related embodiments, the integral insert 500, which is preferably embedded between and below the cylinder chambers 120, is first cast using CGI. Then, the integral insert 500 is cast along with the crankcase 100 to constitute the magnesium alloy engine block using different kinds of materials.

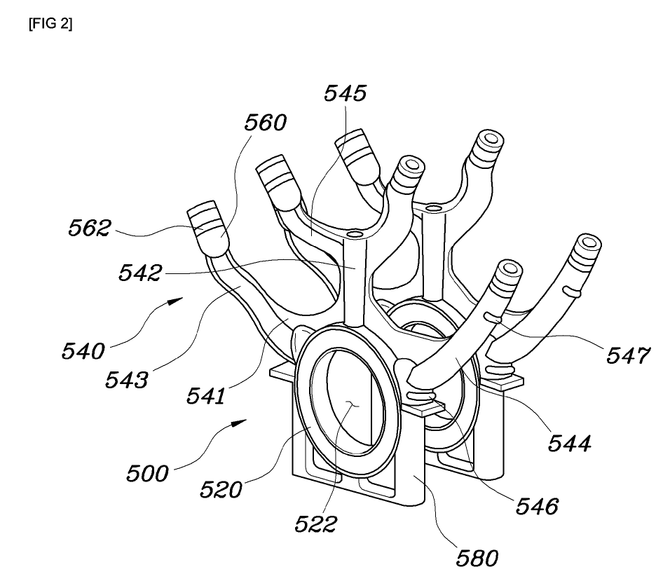

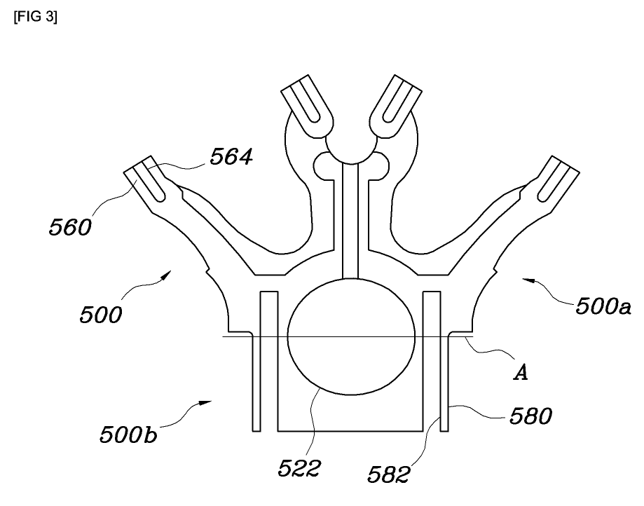

The integral insert 500 according to preferred embodiments is described in detail with reference to exemplary FIGS. 2 and 3. Preferably, the integral insert 500 has the crankshaft support part 520 which is suitably defined with the crankshaft insertion hole 522 at the center portion thereof, the extension parts 540 which upwardly extend from the crankshaft support part 520 toward the cylinder chambers 120, and the upper coupling parts 560 which are suitably formed at the ends of the extension parts 540 and are locked with the upper bolts 340 inserted into the crankcase 100 through the cylinder head 300, the crankshaft support part 520, the extension parts 540 and the upper coupling parts 560 being integrally formed with one another. In further embodiments, the mounting frame 600 is suitably installed on the lower end of the integral insert 500, and lower coupling parts 580 are suitably formed on both sides of the crankshaft insertion hole 522 of the crankshaft support part 520 to be locked with lower bolts 620 which pass through the mounting frame 600. Preferably, the integral insert 500 is formed with the crankshaft support part 520 at the center portion thereof and preferably includes the upper coupling parts 560 which are connected thereto through the extension parts 540 and the lower coupling parts 580.

In preferred embodiments, the upper coupling parts 560 and the lower coupling parts 580 are suitably fastened to the cylinder head 300 and the mounting frame 600 by means of the upper bolts 340 and the lower bolts 620, respectively. Preferably, the integral insert 500 is not an insert for simply reinforcing a bulk head part as in the conventional art, but integrally includes a main bearing cap structure, an area where head bolts are locked, and a crank bore part in which the crankshaft is suitably rotated. Preferably, since the load of the engine and the shocks generated by the rotation of crankshafts and the reciprocation of pistons are concentrated on an insert, the maintenance of the strength of the insert is considered in determining the manufacture of the insert. Accordingly, in the case of the integral insert 500, it is possible to prevent bolts from being loosened due to thermal expansion at a suitable engine operating temperature so that locking force can be ensured. In further preferred embodiments, CGI adopted as the material of the integral insert 500 replaces the conventional cast iron, whereby the weight decreasing effect can be further improved. In other further embodiments, while the integral insert 500 undergoes a splitting process after the engine block is cast, the properties of the CGI material are more appropriate than the conventional cast iron in minimizing the problems caused due to the deformation of the insert that is likely to occur while conducting the splitting process.

According to preferred embodiments of the invention as described herein, the splitting process refers to a process wherein, after the integral insert 500 is formed, the integral insert 500 is cut in such a way as to suitably bisect the crankshaft insertion hole 522 so that the integral insert 500 is divided into an upper insert 500a and a lower insert 500b. Preferably, the upper insert 500a and the lower insert 500b are suitably divided by performing the cutting operation such that the crankshaft insertion hole 522 is bisected as shown in FIG. 3. According to exemplary embodiments, after the upper insert 500a is first integrally cast with the crankcase 100, the crankshaft (not shown) is inserted through the crankshaft insertion hole 522, and then, the lower insert 500b is suitably coupled to the upper insert 500a. In related embodiments, as a result of the splitting process, the cut surfaces of the upper insert 500a and the lower insert 500b are engaged, for example precisely engaged, with each other while forming an original male and female coupling, whereby locking force when assembling the upper insert 500a and the lower insert 500b can be suitably increased compared to the conventional insert. Accordingly, the locking force is suitably effective in maintaining the roundness of a crank bore and preventing deformation due to thermal expansion. Moreover, in further preferred embodiments, the formation of male and female coupling surfaces by the splitting process is possible since the material of the integral insert 500 is preferably CGI. Thus, according to certain preferred embodiments of the invention, by adopting the high strength CGI integral insert 500 and the splitting process, the number of main locking bolts can be suitably decreased from four to two and the sizes thereof can be suitably minimized, to contribute to the lightening of the engine block. In additional embodiments, the low thermal expansion coefficient due to the properties of the material of the integral insert 500 is advantageous in maintaining the roundness of the crankshaft and ensuring lubrication surfaces.

Hereinbelow, the detailed configuration of the integral insert 500 will be described. According to preferred embodiments, the crankshaft support part 520 of the integral insert 500 preferably has the shape of a plate which is defined with the crankshaft insertion hole 522 at the center portion thereof and has a predetermined thickness. Preferably, the extension parts 540 have the shapes of skeletons which suitably connect the crankshaft support part 520 and the upper coupling parts 560. Flange portions 541 are suitably formed on the outer surfaces of the extension parts 540. In exemplary embodiments, for example in the case of an in-line engine, the extension parts preferably extend vertically upward and the upper coupling parts are suitably formed on both sides of the upper ends of the extension parts. In other exemplary embodiments, for example in the case of the V type parallel engine as shown in the drawings, the extension parts 540 preferably have the shapes of branches. To provide further detail, the extension parts 540 are composed of a left skeleton 543, a central skeleton 542 and a right skeleton 544 which upwardly extend from the left end, the upper end and the right end, respectively, of the crankshaft support part 520. Preferably, branch skeletons 545 are branched from the upper end of the central skeleton 542 to extend upward. The upper coupling parts 560 are respectively formed on the ends of the skeletons. In further embodiments, the flange portions 541 are formed on the outer surfaces of the respective skeletons to ensure improved strength and stable coupling.

According to certain preferred embodiments of the invention, the upper coupling part 560 has a cylindrical configuration, and a threaded groove 564 is suitable defined in the upper end of the upper coupling part 560 to be locked with the upper bolt 340. In further related embodiments, the lower coupling part 580 preferably has a cylindrical configuration which downwardly extends on each side of the crankshaft insertion hole 522, and a threaded groove 582 is suitably defined in the lower coupling part 580 to be locked with the lower bolt 620. The threaded groove 582 of the lower coupling part 580 is bisected as the crankshaft insertion hole 522 is bisected along the line ‘A’ by the splitting process, and the lower bolt 620 is locked while passing through the bisected portions of the threaded groove 582.

Preferably, when casting the upper insert 500a and the crankcase 100 which are made of different materials, in order to maintain adhesion therebetween, ribs 546 and 547 are projectedly formed on both ends of the respective extension parts 540 of the integral insert 500. In further embodiments, an annular groove 562 is suitably defined around the upper coupling part 560. Accordingly, due to the presence of the ribs 546 and 547 and the annular groove 562, the casting adhesion is suitably improved, strength is suitably increased, and deformation and breakage are suitably prevented against.

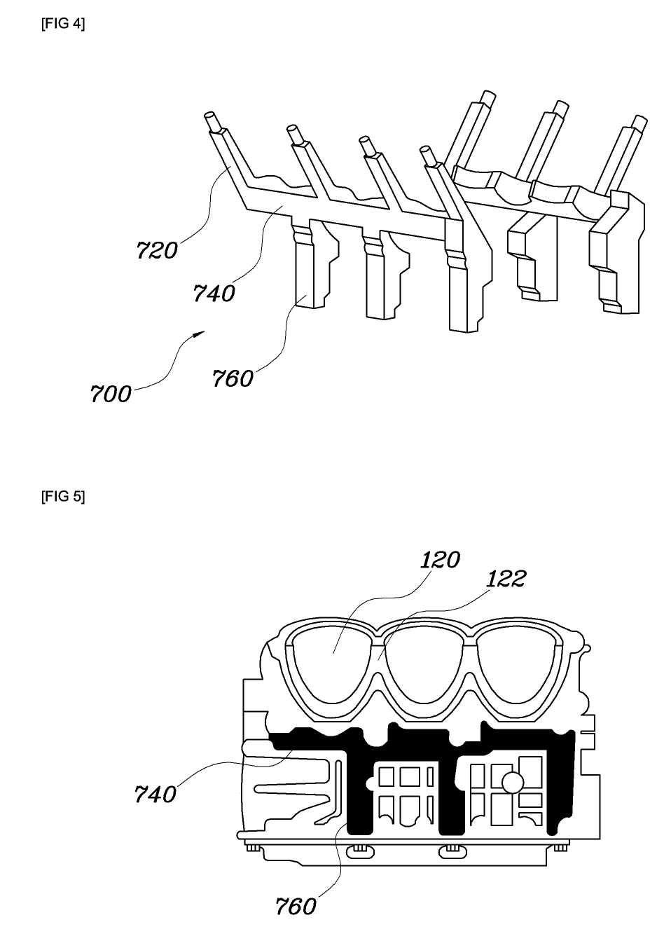

In further embodiments of the invention as described herein, an oil drain will be described with reference to FIGS. 4 and 5. An oil drain 700 is suitably formed outside the cylinder chambers 120 in the crankcase 100. The oil drain 700 is preferably composed of a plurality of upper fluid paths 720 which are formed side by side parallel to the cylinder chambers 120, an intermediate fluid path 740 which suitably connects the lower ends of the upper fluid paths 720 and is formed to extend in the horizontal direction, and a plurality of lower fluid paths 760 which downwardly extend from the intermediate fluid path 740. Preferably, the upper fluid paths 720 are positioned between the cylinder chambers 120, and the lower fluid paths 760 are formed to downwardly extend from the intermediate fluid path 740.

In preferred embodiments, the oil drain 700 is suitably formed using a core such as sand when performing casting. Accordingly, in order to additionally reinforce the structural strength due to the change of the material of the engine block, an integral oil drain 700 is suitably formed to allow a truss structure to be formed inside the magnesium alloy engine block. Preferably, the structure of the oil drain 700 formed in this way not only reinforces twisting and bending strength, but also preferably allows oil not to be dripped onto a rotating driving shaft but to be directly collected in an oil pan, thereby minimizing oil consumption. In order to realize the integrated structure by the manufacturing process, it is necessary to ensure sufficient core strength such that a complicated configuration can be attained using a shell core without being limited by the removal of molds.

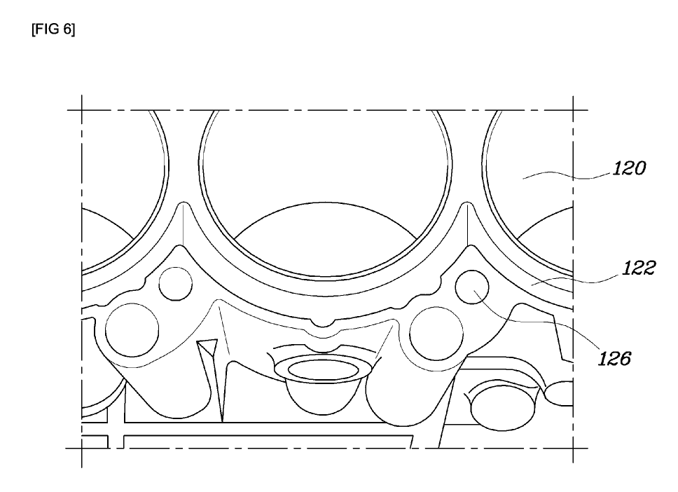

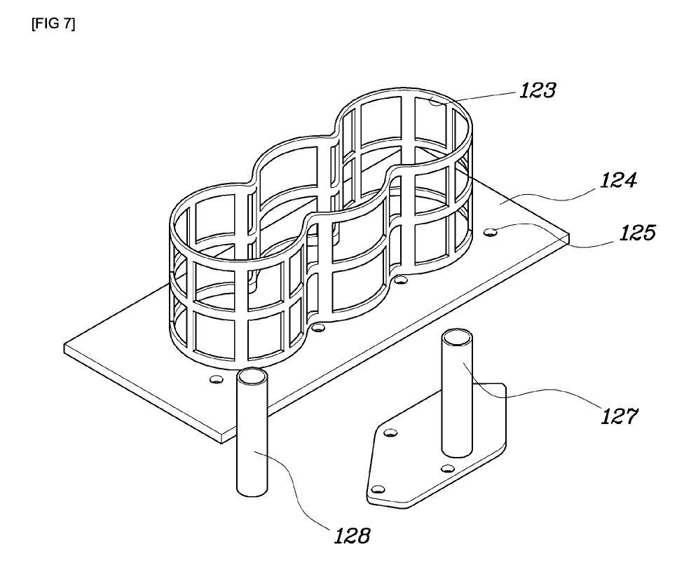

In further exemplary embodiments, the coating of the water jacket 122 will be preferably described with reference to FIGS. 6 through 8. According to certain embodiments, the water jacket 122 is suitably formed in the crankcase 100. The water jacket 122 preferably extends around the cylinder chambers 120, and the inner surface of the water jacket 122 is suitably coated through plasma electrolytic oxidation (PEO). The water jacket 122 also defines an integral fluid path in conformity with the configuration of the integral cylinder chambers 120. In the case of the water jacket 122, by preferably coating the inner surface thereof through PEO, water can be used for the purpose of cooling, and perforation due to corrosion can be suitably prevented. Accordingly, in further preferred embodiments, by applying the coating method only to the water jacket which requires local coating, it is possible to avoid the increase in the manufacturing cost and the larger scale of the manufacturing facilities as compared to coating the entirety of component parts.

Accordingly, by surface-treating only portions or areas of the water jacket where resistance to corrosion caused by the cooling water is most highly required or likely, durability can be suitably improved, convenience in maintenance and repair work is suitably ensured, and the increase in the processing cost can be suitably prevented. In exemplary embodiments, for example as shown in FIG. 6, the water jacket 122 is suitably formed to circulate around the cylinder chambers 120, and bolt holes 126 are defined outside the water jacket 122 to be locked with the upper bolts 340. FIG. 7 illustrates exemplary configurations of an electrode 123 and jigs 127 and 128. According to preferred embodiments, the electrode 123 is suitably inserted into the water jacket 122 in such a way as not to be brought into contact with the inner surface of the water jacket 122. Electrolyte is circulated through cooling water paths using the jigs 127 and 128. The electrode 123 is formed on a closure member 124. The closure member 124 closes the upper ends of the cylinder chambers 120, and holes 125 are suitably defined at positions corresponding to the bolt holes 126.

Preferably, on the PEO process, by suitably positioning a metal (such as stainless steel, Pt-based alloy, and the like) having relatively high electrical stability on a cathode and a metal for oxidation on an anode and applying alternate or direct current power, an oxide film is formed. The gas (O₂ or H₂) which reacts when forming the oxide film generates plasma by a locally produced strong current field, and this energy serves to fuse the instantaneously formed oxide, so that densified and firm oxide can be created. Thus, in further preferred embodiments, the plasma generated by the PEG coating electrode in this way, which is directly installed in the water jacket, can preferably form the densified oxide layer on the surface of the magnesium alloy, unlike the porous oxide layer formed according to the conventional anodizing process or image processing, so that resistance against the corrosion caused by cooling water and durability against erosion can be suitably provided and the same properties can be ensured even by a thin film to provide superiority in relation to the heat conductivity of the engine block.

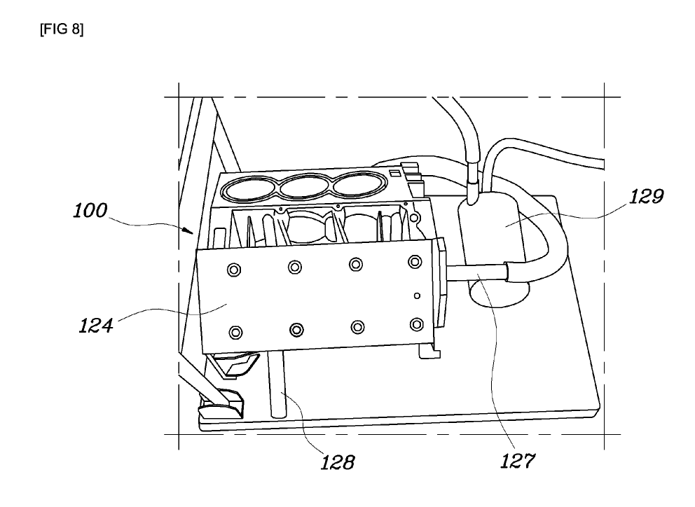

FIG. 8 illustrates the state in which the electrode and the jigs for coating the water jacket are suitably installed. Preferably, the electrode is formed to have a configuration corresponding to the water jacket, is suitably inserted into the water jacket through the upper end of the water jacket, and is suitably locked by the upper bolts. By selecting the positions and the specifications of the bolts for fastening the closure member 124 constituting the electrode to be the same as those of the upper bolts, the airtightness of the water jacket can be suitably ensured without separately defining holes. In related embodiments, after the electrode is locked, by locking the jigs 127 and 128 for connecting the cooling water inlet and outlet of the engine block to a circulation pump 129, using the bolt holes defined in the engine block in the same manner as in the case of locking the electrode, the electrolytic flowing through the cooling water path of the engine block can suitably constitute a single circulation circuit. Preferably, by performing the PEO coating by using the apparatus while flowing the electrolytic through the cooling water path, the densified oxide film can be formed not on the entire surface of the engine block but only on the inner surface of the water jacket on which the cooling water flows. Accordingly, while preventing corrosion and erosion caused by the cooling water, the thickness of the oxide film can be suitably controlled to the minimum in such a way as not to deteriorate the heat conductivity of the combustion chambers of the engine block.

As is apparent from the above description, in the magnesium alloy engine block according to the present invention constructed as mentioned above, thanks to the use of integral inserts, rigidity in the magnesium alloy engine block is suitably increased, and thermal deformation is suitably prevented. Also, the strength of the magnesium alloy engine block is suitably increased owing to the configuration of an integral oil drain.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A magnesium alloy engine block for a vehicle, having an upper end to which a cylinder head is coupled, comprising:
a crankcase formed of magnesium alloy and having a plurality of cylinder chambers in which pistons are to be disposed and a water jacket which is formed around the cylinder chambers and is coated on an inner surface thereof through plasma electrolytic oxidation;
a cylindrical liner fitted into the cylinder chambers; and
an integral insert embedded into the crankcase between and below the cylinder chambers and having a crankshaft support part which is defined with a crankshaft insertion hole at a center portion thereof, extension parts which upwardly extend from the crankshaft support part toward the cylinder chambers, and upper coupling parts which are formed at ends of the extension parts and are locked with upper bolts inserted into the crankcase through a cylinder head, the crankshaft support part, the extension parts and the upper coupling parts being integrally formed with one another.

2. The magnesium alloy engine block according to claim 1, wherein a mounting frame is installed on a lower end of the integral insert, and lower coupling parts are formed on both sides of the crankshaft insertion hole of the crankshaft support part to be locked with lower bolts which pass through the mounting frame.

3. The magnesium alloy engine block according to claim 1, wherein the integral insert is integrally formed of compacted graphite iron and is then cut in a manner such that the crankshaft insertion hole is bisected and the integral insert is divided into an upper insert and a lower insert.

4. The magnesium alloy engine block according to claim 1, wherein the crankshaft support part of the integral insert has the shape of a plate which is defined with the crankshaft insertion hole at a center portion thereof and has a predetermined thickness, the extension parts have the shapes of skeletons which connect the crankshaft support part and the upper coupling parts, and flange portions are formed on outer surfaces of the extension parts.

5. The magnesium alloy engine block according to claim 4, wherein the extension parts are composed of a left skeleton, a central skeleton and a right skeleton which upwardly extend from a left end, an upper end and a right end, respectively, of the crankshaft support part, branch skeletons are branched from an upper end of the central skeleton to extend upward, and the upper coupling parts are respectively formed on upper ends of the skeletons.

6. The magnesium alloy engine block according to claim 1, wherein ribs are projectedly formed on both ends of the respective extension parts so that adhesion is improved when the integral insert is cast along with the crankcase.

7. The magnesium alloy engine block according to claim 1, wherein an annular groove is defined around each upper coupling part so that adhesion is improved when the integral insert is cast along with the crankcase.

8. The magnesium alloy engine block according to claim 1, wherein an oil drain is formed outside the cylinder chambers in the crankcase, and is composed of a plurality of upper fluid paths which are formed side by side parallel to the cylinder chambers, an intermediate fluid path which connects lower ends of the upper fluid paths and is formed to extend in a horizontal direction, and a plurality of lower fluid paths which downwardly extend from the intermediate fluid path.

9. The magnesium alloy engine block according to claim 1, wherein the liner comprises an integral liner which is formed of aluminum alloy such that a plurality of cylindrical liners are integrated with one another, and the cylinder chambers of the crankcase communicate with one another to constitute an integral cylinder chamber such that the integral liner can be fitted into the integral cylinder chamber.

10. The magnesium alloy engine block according to claim 1, wherein the water jacket is coated by an electrode inserted therein with electrolytic which is circulated through a cooling water inlet and outlet of the water jacket, and the electrode has a configuration corresponding to the water jacket and is inserted in such a way as not to be brought into contact with an inner surface of the water jacket.

11. A magnesium alloy engine block for a vehicle, having an upper end to which a cylinder head is coupled, comprising:
a crankcase formed of magnesium alloy and having a plurality of cylinder chambers in which pistons are to be disposed;
a cylindrical liner fitted into the cylinder chambers; and
an integral insert embedded into the crankcase between and below the cylinder chambers and having a crankshaft support part, extension parts, and upper coupling parts, the crankshaft support part, the extension parts and the upper coupling parts being integrally formed with one another.

12. The magnesium alloy engine block for a vehicle of claim 11, wherein the crankcase further comprises a water jacket which is formed around the cylinder chambers.

13. The magnesium alloy engine block for a vehicle of claim 12, wherein the water jacket is coated on an inner surface.

14. The magnesium alloy engine block for a vehicle of claim 13, wherein the water jacket is coated on an inner surface through plasma electrolytic oxidation.

15. The magnesium alloy engine block for a vehicle of claim 11, wherein the integral insert embedded into the crankcase between and below the cylinder chambers further comprises a crankshaft support part defined with a crankshaft insertion hole at a center portion thereof.

16. The magnesium alloy engine block for a vehicle of claim 11, wherein the extension parts upwardly extend from the crankshaft support part toward the cylinder chambers.

17. The magnesium alloy engine block for a vehicle of claim 11, wherein the upper coupling parts are formed at ends of the extension parts and are locked with upper bolts inserted into the crankcase through a cylinder head.

18. A motor vehicle comprising the magnesium alloy engine block of claim 1.

19. A motor vehicle comprising the magnesium alloy engine block of claim 11.
